(19) United States
(12) Patent Application Publication
(10) Pub. No.: US 2009/0041971 A1
(43) Pub. Date: Feb. 12, 2009

(54) POLARIZER FILMS AND METHODS OF MAKING THE SAME

(75) Inventors: Jian Jim Wang, Orefield, PA (US); Xiaoming Liu, Orefield, PA (US); Feng Liu, Allentown, PA (US); Xuegong Deng, Piscataway, NJ (US)

Correspondence Address: FISH & RICHARDSON PC, P.O. BOX 1022, MINNEAPOLIS, MN, 55440-1022, US

(73) Assignee: API Nanofabrication and Research Corp., Somerset, NJ (US)

(21) Appl. No.: 12/191,965

(22) Filed: Aug. 14, 2008

Related U.S. Application Data
(63) Continuation of application No. 11/956,219, filed on Dec. 13, 2007, now abandoned.
Application No. 11/956,219 is a continuation of application No. 11/784,975, filed on Apr. 10, 2007, now abandoned.
(60) Provisional application No. 60/837,829, filed on Aug. 15, 2006.
(60) Provisional application No. 60/883,194, filed on Jan. 3, 2007.

(51) Int. Cl. B32B 3/10

(52) U.S. Cl. 428/54

(57) ABSTRACT

In general, in one aspect, the invention features an article that includes a layer including a plurality of spaced-apart portions of a first material extending along a first direction. The layer transmits about 20% or more of light of wavelength λ having a first polarization state incident on the layer along a path. The layer transmits about 2% or less of light of wavelength λ having a second polarization state incident on the layer along the path, the first and second polarization states being orthogonal. For wavelength λ, the first material has a refractive index of 1.8 or more and an extinction coefficient of 1.8 or more, and λ is 300 nm or less.

### CROSS-REFERENCE TO RELATED APPLICATIONS

This application is a continuation of and claims benefit of U.S. patent application Ser. No. 11/956,219, POLARIZER FILMS AND METHODS OF MAKING THE SAME, filed on Dec. 13, 2007, which claims benefit of Ser. No. 11/784,975, entitled “POLARIZER FILMS AND METHODS OF MAKING THE SAME,” filed on Apr. 10, 2007, which claims benefit of Provisional Patent Application No. 60/837,829, entitled “METHODS FOR FORMING PATTERNED STRUCTURES,” filed on Aug. 15, 2006, and of Provisional Patent Application No. 60/883,194, entitled “POLARIZER FILMS AND METHODS OF MAKING THE SAME, filed on Jan. 3, 2007. The entire contents of all of the above-referenced applications are incorporated herein by reference.

### TECHNICAL FIELD

This invention relates to polarizer films and related articles, systems and methods.

### BACKGROUND

Optical devices and optical systems are commonly used where manipulation of light is desired. Examples of optical devices include lenses, polarizers, optical filters, antireflection devices, retarders (e.g., quarter-waveplates), and beam splitters (e.g., polarizing and non-polarizing beam splitters). Optical devices can be in the form of a film.

### SUMMARY

This disclosure relates to polarizer films, articles containing such films, methods for making such films, and systems that utilize such films.

In general, in a first aspect, the invention features an article that includes a layer including a plurality of spaced-apart portions of a first material extending along a first direction. The layer transmits about 20% or more of light of wavelength λ having a first polarization state incident on the layer along a path. The layer transmits about 2% or less of light of wavelength λ having a second polarization state incident on the layer along the path, the first and second polarization states being orthogonal. For wavelength λ, the first material has a refractive index of 1.8 or more and an extinction coefficient of 1.8 or more, and λ is 300 nm or less.

Embodiments of the article can include one or more of the following features. For example, in some embodiments, the first material is a metal, such as tungsten (W), titanium (Ti), chromium (Cr), nickel (Ni), platinum (Pt), molybdenum (Mo), vanadium (V), palladium (Pd), or iridium (Ir). In certain embodiments, the first material is a metal oxide, such as titanium dioxide (TiO₂) or indium tin oxide (ITO). The first material can be a semiconductor material, such as silicon (Si), germanium (Ge), indium phosphide (InP), or silicon-germanium (SiGe). In some embodiments, the first material is a metal silicide.

The adjacent spaced apart portions can be separated by a distance of about 150 nm or less (e.g., about 120 nm or less, about 100 nm or less, about 80 nm or less, about 60 nm or less, about 50 nm or less, about 40 nm or less). The spaced apart portions can have a width of about 100 nm or less (e.g., about 60 nm or less, about 50 nm or less, about 40 nm or less, about 30 nm or less, about 25 nm or less, about 20 nm or less, about 15 nm or less, about 12 nm or less, such as about 10 nm). The spaced apart portions can have a depth of about 30 nm or more (e.g., about 40 nm or more, about 50 nm or more, about 60 nm or more, about 80 nm or more, about 100 nm or more, about 120 nm or more). The spaced apart portions can have an aspect ratio of about 1:1 or more (e.g., about 1.5:1 or more, about 2:1 or more, about 3:1 or more, about 4:1 or more).

The spaced apart portions can be arranged to form a grating. The grating can have a period of about 200 nm or less (e.g., about 150 nm or less, about 120 nm or less, about 100 nm or less). The grating can have a duty cycle of about 60% or less (e.g., about 50% or less, about 40% or less, about 30% or less, about 20% or less). The grating can have a rectangular, trapezoidal, or triangular cross-sectional profile.

In some embodiments, the article further includes a plurality of spaced apart portions of a second material extending along the first direction, wherein the first and second materials are different. The second material can be a metal, such as aluminum (Al), gold (Au), silver (Ag), or copper (Cu), for example. Alternatively, the second material can be a dielectric material. In some embodiments, the second material is an oxide. Every two portions of the first material can be disposed on opposing surfaces of a corresponding portion of the second material. For example, the two portions of the first material can form side walls of the corresponding portion of the second material. Portions of the first material that form side walls of adjacent portions of the second material can be separated by a gap or by portions of another material (e.g., a material different from the first and second materials).

λ can be about 280 nm or less, such as about 260 nm or less. In some embodiments, λ is in a range from about 200 nm to about 280 nm (e.g., in a range from about 230 nm to about 260 nm).

In some embodiments, the layer transmits about 30% or more (e.g., about 40% or more, about 50% or more, about 60% or more) of light of wavelength λ having the first polarization state incident on the layer along the path. The layer can transmit about 1% or less of light of wavelength λ having the second polarization state incident on the layer along the path. The layer can have an extinction ration of about 30 or more at λ. In some embodiments, the layer reflects about 20% or less of light of wavelength λ having the second polarization state incident on the layer along the path.

In certain embodiments, the article further includes a second layer including a plurality of spaced-apart portions of a second material extending along the first direction, the second material being different from the first material. The second layer transmits about 20% or more of light of wavelength λ′ having the first polarization state incident on the layer along the path and transmits about 2% or less of light of wavelength λ′ having the second polarization state incident on the layer along the path, the first and second polarization states being orthogonal, and λ<λ′. In some embodiments, the second layer reflects about 20% or more (e.g., about 50% or more, about 60% or more about 80% or more) of light of wavelength λ′ having the second polarization state incident on the layer along the path. λ′ can be in a range from about 400 nm to about 700 nm. In certain embodiments, the first material is a dielectric material and the second material is a metal.

The article can include a substrate supporting the layer. For example, the article can include a glass or plastic substrate.

In another aspect, the invention features a system that includes a radiation source and an article as discussed with respect to other aspects of the invention, where the radiation source is configured to direct radiation at λ toward the article. The system can further include a support for a substrate, where the support is configured to position the substrate to receive the radiation transmitted by the article. The system can be part of a fabrication facility, such as a liquid crystal display fabrication facility. In certain embodiments, the system is a metrology system configured to inspect a substrate, such as a semiconductor wafer, for example.

In a further aspect, the invention features a method that includes using an article as discussed with respect to other aspects of the invention to provide polarized radiation at λ and directing the polarized radiation to a target. The target can be a substrate, such as a substrate of a flat panel display substrate or a semiconductor wafer. In some embodiments, the target includes an alignment layer (e.g., a photosensitive polymer) for a liquid crystal display.

In general, in a further aspect, the invention features an article that includes a layer including a plurality of spaced-apart portions of a first material extending along a first direction. The layer transmits about 20% or more of light of wavelength λ having a first polarization state incident on the layer along a path. The layer transmits about 2% or less of light of wavelength λ having a second polarization state incident on the layer along the path, the first and second polarization states being orthogonal. The first material is a metal oxide, tungsten, or silicon, and λ is 300 nm or less. Embodiments of the article can include one or more of the features discussed above with respect to the first aspect of the invention.

In general, in another aspect, the invention features an article that includes a layer including a plurality of spaced-apart portions of a first material extending along a first direction. For a cross-sectional profile through the layer orthogonal to the first direction, adjacent portions have a minimum separation of about 100 nm or less and the portions have a width of about 100 nm or less. For wavelength λ, the first material has a refractive index of 1.8 or more and an extinction coefficient of 1.8 or more, and λ is 300 nm or less. Embodiments of the article can include one or more of the features discussed above with respect to the first aspect of the invention.

In general, in a further aspect, the invention features an article that includes a layer including a plurality of spaced-apart portions of a first material extending along a first direction. For a cross-sectional profile through the layer orthogonal to the first direction, adjacent portions have a minimum separation of about 100 nm or less and the portions have a width of about 100 nm or less. The first material is a metal oxide, tungsten, or silicon, and λ is 300 nm or less. Embodiments of the article can include one or more of the features discussed above with respect to the first aspect of the invention.

In general, in another aspect, the invention features an article that includes a layer including a plurality of spaced apart portions of a first material arranged to form a first grating having a first period and a plurality of spaced apart portions of a second material arranged to form a second grating having a second period. The first and second periods are different, one of the first and second materials is a metal, the other of the first and second materials is a dielectric material, and adjacent portions of the first material are separated by two adjacent portions of the second material. Embodiments of the article can include one or more of the features discussed above with respect to the first aspect of the invention.

In certain aspects, gratings formed from materials with a refractive index and extinction coefficient of 1.5 or more at a wavelength λ can be used as a polarizer for radiation at %. It is believed that absorption at % (e.g., in the UV) by the material forming the gratings generates the polarization effect. This aspect can differ from a conventional wire-grid polarizer which typically utilizes materials with high reflectivity at the operating wavelength.

Certain materials with refractive indexes and extinction coefficients of 1.5 or more (e.g., TiO₂ and W) can be deposited using atomic layer deposition. This deposition method can be used to form gratings with short periods, narrow line widths, and high aspect ratios, suitable for polarizing radiation in the UV portion of the electromagnetic (EM) spectrum.

Because of the absorption principle, it is believed that the width of the portions forming the polarizing structure should be very thin in order to avoid excessive absorption of the pass state light. For example, for certain embodiments configured to polarize UV radiation, the gratings may have a period of about 150 nm or less (e.g., about 100 nm or less), while the portions forming the grating may have a width of about 10 nm to 15 nm to provide sufficient pass state transmission, whereas for widths of 30 nm to 40 nm or more, the pass state transmission can be unacceptably low for certain target applications.

Among other advantages, embodiments disclosed herein can include polarizer films for use in the UV portion of the EM spectrum. Embodiments include polarizer films that feature gratings formed from materials that absorb radiation at the operating wavelength(s).

The polarizer films can exhibit good resistance to environmental degradation. For example, compared to polarizers formed from materials which can oxidize over time thereby degrading performance, embodiments can include polarizer films formed from materials which don't oxidize in the same way, for example, the metal grid lines do in certain wire grid polarizers. The environmental resistance can be especially pronounced for polarizer gratings in which the material used to form the grating has a high surface to volume ratio, for example, gratings having very narrow line widths (e.g., line widths of about 50 nm or less) and/or high aspect ratios.

Embodiments include broadband polarizers operational in the UV and visible portions of the spectrum. For example, in some embodiments, gratings are formed from materials that absorb and/or reflect radiation across a broad spectrum, including portions of the UV and visible portions of the spectrum. For example, gratings formed from Tungsten can be used for polarization of UV and visible wavelengths. In certain embodiments, polarizers can include gratings formed from two or more different materials, where one material is selected to provide polarization in one region of the EM spectrum, while another material is selected to provide polarization in a different region of the EM spectrum. For example, polarizers can include a grating formed from TiO₂ and a grating formed from a metal, such as aluminum. The TiO₂ grating provides polarization in the 200 nm to 310 nm range, and the aluminum grating provides polarization in the visible.

In certain embodiments, polarizer films can be configured to polarize radiation in the infrared (IR) region of the EM spectrum (e.g., in a range from about 1,200 nm to about 2,000 nm).

Other features, and advantages of the invention will be apparent from the description and drawings, and from the claims.

### DESCRIPTION OF DRAWINGS

FIG. 1A is a cross-sectional view of an embodiment of a polarizer film.

FIG. 1B is a plan view of an embodiment of a polarizer film.

FIG. 2 is a cross-sectional view of an embodiment of a polarizer film.

FIG. 3A-3D are cross-sectional views of embodiments of polarizer films.

FIG. 4 is a cross-sectional view of an embodiment of a polarizer film.

FIG. 5A-5C are cross-sectional views of structures in various stages in the fabrication of an embodiment of a polarizer film.

FIG. 6 is a plot showing modeled optical performance as a function of wavelength for an embodiment of a polarizer film.

FIG. 7 is a plot showing modeled optical performance as a function of wavelength for an embodiment of a polarizer film.

FIG. 8 is a plot showing modeled optical performance as a function of wavelength for an embodiment of a polarizer film.

FIG. 9 is a plot showing modeled optical performance as a function of wavelength for an embodiment of a polarizer film.

FIG. 10A is a schematic diagram of an atomic layer deposition system.

FIG. 10B is a flow chart showing steps for forming a nanolaminate using atomic layer deposition.

FIG. 11A is a plot showing measured optical performance as a function of wavelength for an embodiment of a polarizer film.

FIG. 11B is a plot showing measured optical performance as a function of wavelength for an embodiment of a polarizer film.

FIG. 12 is a schematic diagram of an exposure system.

Like reference symbols in the various drawings indicate like elements.

### DETAILED DESCRIPTION

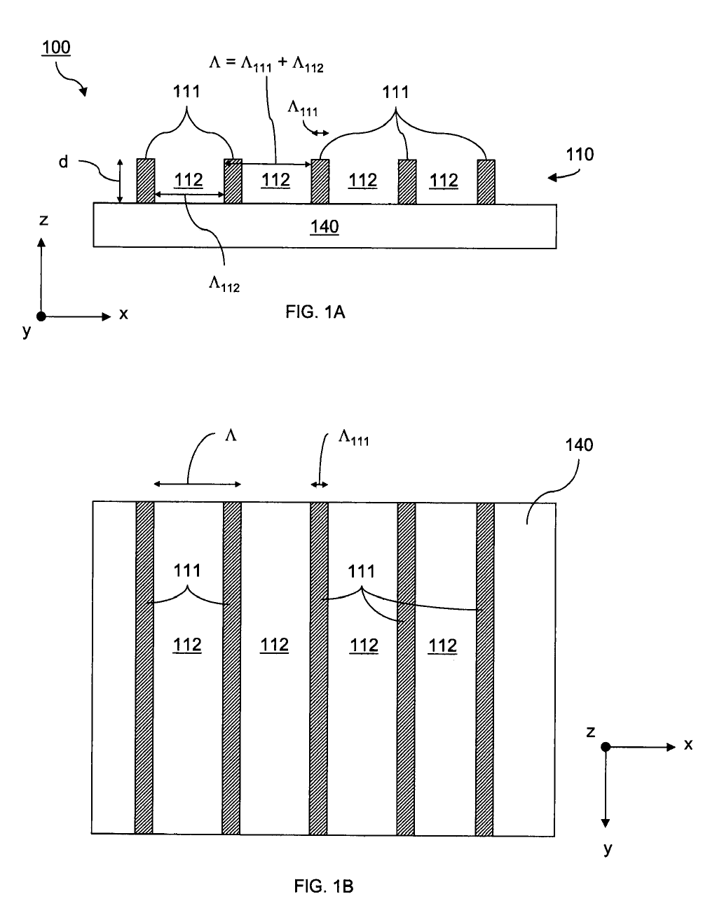

Referring to FIGS. 1A and 1B, a linear polarizer film 100 includes a grating layer 110 and a substrate 140. Grating layer 110 includes elongated portions 111 that extend along the y-direction of the Cartesian coordinate system shown in FIGS. 1A and 1B. Portions 111 are arranged to form a grating having a period Λ. The different compositions have different optical properties for light of wavelength λ₁.

Grating layer 110 linearly polarizes incident light of wavelength λ₁ propagating parallel to the z-axis. In other words, for light of wavelength λ₁ incident on linear polarizer film 100 propagating parallel to the z-axis, linear polarizer film 100 transmits a relatively large amount of the component of incident light plane-polarized in the x-direction (referred to as “pass” state polarization) compared to the amount of the component plane-polarized in the y-direction (referred to as “block” state polarization). For example, polarizer film 100 can transmit about 25% or more (e.g., about 30% or more, about 40% or more, about 50% or more, about 60% or more, about 80% or more) of pass state light at A, while passing about 5% or less of the block state light (e.g., about 4% or less, about 3% or less, about 2% or less, about 1% or less, about 0.5% or less, 0.3% or less, 0.2% or less, 0.1% or less) at λ₁. λ₁ can correspond to a local (or global) maximum in the pass state transmission spectrum. Alternatively, or additionally, λ₁ can correspond to a local (or global) minimum in the block state transmission spectrum.

In general, λ₁ is between about 100 nm and about 5,000 nm. In certain embodiments, λ₁ corresponds to a wavelength within the visible portion of the EM spectrum (e.g., from 400 nm to 700 nm). In some embodiments, λ₁ corresponds to a wavelength in the UV portion of the EM spectrum (e.g., from about 100 nm up to 400 nm), such as about 250 nm.

In some embodiments, linear polarizer film 100 polarizes radiation at more than one wavelength. For example, linear polarizer film 100 can polarize radiation at wavelengths λ₁ and λ₂, where λ₁<λ₂ and |λ₁−λ₂| is about 50 nm or more (e.g., about 75 nm or more, about 100 nm or more, about 150 nm, about 200 nm or more, about 250 nm or more, about 300 nm or more, about 400 nm or more, about 500 nm or more). In certain embodiments, linear polarizer film 100 can polarize radiation for a continuous band of wavelengths, Δλ, that includes λ₁ and λ₂. For example, linear polarizer film 100 can polarize radiation for a band of wavelengths, Δλ, about 10 nm wide or more (e.g., about 20 nm wide or more, about 50 nm wide or more, about 80 nm wide or more, about 100 nm or more, about 200 nm or more, about 300 nm or more, about 400 nm n or more). λ₂ can correspond to a local (or global) maximum in the pass state transmission spectrum. Alternatively, or additionally, λ₂ can correspond to a local (or global) minimum in the block state transmission spectrum.

Furthermore, while linear polarizer film 100 polarizes incident radiation propagating parallel to the z-axis, in some embodiments, polarizer film 100 can polarize radiation at λ₁ for radiation at non-normal angles of incidence (i.e., for radiation incident on linear polarizer film 100 propagating at an angle θ with respect to the z-axis, where θ is non-zero). In certain embodiments, linear polarizer film 100 can polarize radiation incident at more than one angle of incidence, such as for a range of incident angles. For example, in some embodiments, linear polarizer film 100 polarizes radiation incident within a cone of incident angles for θ of about 10° or more (e.g., about 15° or more, about 20° or more, about 30° or more, about 45° or more). Note that for non-normal incidence, the pass state corresponds to light polarized parallel to the x-z plane, while the block state corresponds to light polarized orthogonal to the x-z plane.

In embodiments, linear polarizer film 100 blocks a relatively large amount of incident radiation at λ₁ and/or λ₂ having the block state polarization by absorbing a relatively large amount of the block state radiation. For example, linear polarizer film 100 can absorb about 80% or more of incident radiation at λ₁ and/or λ₂ having the block polarization state (e.g., about 90% or more, about 95% or more, about 98% or more, about 99% or more). In some embodiments, block state reflection from polarizer film 100 is relatively low. For example, polarizer film 100 can reflect about 50% or less (e.g., about 20% or less, about 15% or less, about 10% or less, about 5% or less) of incident block state radiation at λ₁. In certain embodiments, polarizer film 100 can reflect about 50% or less (e.g., about 20% or less, about 15% or less, about 10% or less, about 5% or less) of incident block state radiation at λ₁ and λ₂. Alternatively, in some embodiments, polarizer film 100 can reflect about 50% or less (e.g., about 20% or less, about 15% or less, about 10% or less, about 5% or less) of incident block state radiation at λ₁, while reflecting about 50% or more (e.g., about 60% or more, about 70% or more, about 80% or more, about 90% or more) of incident block state radiation at λ₂.

Linear polarizer film 100 can have a relatively high extinction ratio, E_{T}, for transmitted light at λ₁ and/or λ₂. For transmitted light, the extinction ratio refers to the ratio of pass state intensity at λ₁ and/or λ₂ to the block state intensity transmitted by linear polarizer film 100. Extinction ratio is also referred to as polarizer contrast. E_{T} can be, for example, about 10 or more at λ₁ and/or λ₂ (e.g., about 20 or more, about 30 or more, about 40 or more, about 50 or more, about 60 or more, about 70 or more, about 80 or more, about 90 or more, about 100 or more, about 150 or more, about 300 or more, about 500 or more). In some embodiments, λ₁ corresponds to a local (or global) maximum in the extinction ratio as a function of wavelength, E_{T}(λ). Alternatively, or additionally, λ₂ can correspond to a local (or global) maximum in E_{T}(λ).

The extinction ratio of a polarizer can also be expressed in decibels (dB) rather than as a ratio, where the relationship between the ratio E_{T} and its corresponding dB value can be determined according to the equation:

E_{T,dB}=10·log₁₀E_{T}.

For example, an extinction ratio of 30 corresponds to approximately 15 dB, an extinction ratio of 50 corresponds to approximately 17 dB, and an extinction ratio of 100 corresponds to 20 dB.

Linear polarizer film 100 can exhibit good resistance to degradation, e.g., due to exposure to environmental or operational factors. Such factors include, for example, humidity, heat, exposure to an oxidant (e.g., air), and/or radiation. In general, good resistance to degradation means that the optical performance (e.g., pass state transmission, block state transmission, extinction ratio) of linear polarizer film varies relatively little with prolonged exposure to one or more of the environmental or operational factors. For example, in embodiments where linear polarizer film 100 is used as a polarizer for UV radiation, the polarizer film can exhibit little variation in optical performance over substantial periods (e.g., 100 hours or more, 500 hours or more, 1,000 hours or more) of exposure to the radiation.

One way to characterize a linear polarizer's resistance to environmental degradation is by controlled environmental testing, such as exposure to an elevated temperature in a controlled atmosphere. As an example, a linear polarizer can be exposed to an oxygen environment at a temperature of about 650° C. for 6 hrs. Linear polarizer films with good resistance to degradation exhibit a decrease in transmittance at λ₁ of about 8% or less (e.g., 5% or less, 4% or less, 3% or less, 2% or less, 1% or less) as measured before and after the exposure. Linear polarizer films with good resistance to degradation can also exhibit a decrease in E_{T} at λ₁ of about 8% or less (e.g., 5% or less, 4% or less, 3% or less, 2% or less, 1% or less) as measured before and after the exposure.

As a further example, another way to test environmental stability is by prolonged exposure to a high power UV emission source for extended periods. Specifically, a linear polarizer film can be tested by positioning the polarizer 2 cm from a 1,000 W Mercury Arc Lamp (e.g., Model Code UVH 1022-0 available from Ushio America, Cypress, Calif.). The polarizer film is oriented so that light from the source is incident on the polarizer along z-axis. E_{T} is measured at λ₁ before and after exposure. Embodiments of linear polarizer films with good resistance to degradation can also exhibit a decrease in E_{T} at λ₁ of about 8% or less (e.g., 5% or less, 4% or less, 3% or less, 2% or less, 1% or less) as measured before and after the exposure.

Turning now to the structure of grating layer 110, elongated portions 111 extend along the y-direction, forming a periodic grating composed of a series of portions separated by gaps 112. The portions corresponding to portions 111 have a width Λ₁₁₁ in the x-direction, while the gaps 112 have a width Λ₁₁₂ in the x-direction. The grating period, Λ, equal to Λ₁₁₁+Λ₁₁₂, is smaller than λ₁ and as a result light of wavelength λ₁ interacts with grating layer 110 without encountering significant high-order, far-field diffraction that can occur when light interacts with periodic structures. Where λ₁ is in the visible or UV portion of the EM spectrum, grating layer 110 can be considered an example of a nanostructured layer.

In general, Λ₁₁₁ can be about 0.2 λ₁ or less (e.g., about 0.1 λ₁ or less, about 0.05 λ₁ or less, about 0.04 λ₁ or less, about 0.03 λ₁ or less, about 0.02 λ₁ or less, 0.01 λ₁ or less). For example, in some embodiments, Λ₁₁₁ is about 200 nm or less (e.g., about 150 nm or less, about 100 nm or less, about 80 nm or less, about 70 nm or less, about 60 nm or less, about 50 nm or less, about 40 nm or less, about 30 nm or less). In some embodiments, Λ₁₁₁ is about 10 nm or more (e.g., about 15 nm or more, about 20 nm or more). Similarly, Λ₁₁₂ can be about 0.2 λ₁, or less (e.g., about 0.1 λ₁ or less, about 0.05 λ₁ or less, about 0.04 λ₁ or less, about 0.03 λ₁ or less, about 0.02 λ₁ or less, 0.01 λ₁ or less). For example, in some embodiments, Λ₁₁₂ is about 200 nm or less (e.g., about 150 nm or less, about 100 nm or less, about 80 nm or less, about 70 nm or less, about 60 nm or less, about 50 nm or less, about 40 nm or less, about 30 nm or less). Λ₁₁₁ and Λ₁₁₂ can be the same as each other or different.

In general, Λ is less than λ₁, such as about 0.5 λ₁ or less (e.g., about 0.3 λ₁ or less, about 0.2 λ₁ or less, about 0.1 λ₁ or less, about 0.08 λ₁ or less, about 0.05 λ₁ or less, about 0.04 λ₁ or less, about 0.03 λ₁ or less, about 0.02 λ₁ or less, 0.01 λ₁ or less). In some embodiments, Λ is about 500 nm or less (e.g., about 300 nm or less, about 200 nm or less, about 150 nm or less, about 130 nm or less, about 100 nm or less, about 80 nm or less, about 60 nm or less, about 50 nm or less, about 40 nm or less).

The duty cycle of grating layer, given by the ratio Λ₁₁₁:Λ, can vary as desired. In some embodiments, the duty cycle is less than about 50% (e.g., about 40% or less, about 30% or less, about 20% or less, about 10% or less, about 8% or less). Alternatively, in certain embodiments, the duty cycle is more than about 50% (e.g., about 60% or more, about 70% or more, about 80% or more).

In general, the number of portions 111 in a grating layer may vary as desired. The number of portions depends on the period, Λ, and the area required by the linear polarizer's end use application. In some embodiments, grating layer 110 can have about 50 or more portions (e.g., about 100 or more portions, about 500 or more portions, about 1,000 or more portions, about 5,000 or more portions, about 10,000 or more portions, about 50,000 or more portions, about 100,000 or more portions, about 500,000 more portions).

The thickness, d, of grating layer 110 measured along the z-axis can vary as desired. In general, the thickness of layer 110 is selected based on the desired optical properties of grating layer 110 at λ₁ and constraints on the manufacturability of such structures. In some embodiments, d can be about 50 nm or more (e.g., about 75 nm or more, about 100 nm or more, about 125 nm or more, about 150 nm or more, about 200 nm or more, about 250 nm or more, about 300 nm or more, about 400 nm or more, about 500 nm or more, about 1,000 or more, such as about 2,000 nm).

The aspect ratio of grating layer thickness, d, to Λ₁₁₁ and/or d to Λ₁₁₂ can be relatively high. For example d:Λ₁₁₁ and/or d:Λ₁₁₂ can be about 2:1 or more (e.g., about 3:1 or more, about 4:1 or more, about 5:1 or more, about 8:1 or more, about 10:1 or more, about 12:1 or more, about 15:1 or more).

In general, the composition of portions 111 are selected so that polarizer film 100 has desired polarizing properties. The composition of portions 111 are also selected based factors such as their compatibility with the manufacturing processes used in production of polarizer film 100 and their environmental properties, such as resistance to degradation due to environmental exposure.

In embodiments, portions 111 are formed from materials that have relatively low transmissivity at λ₁. A one micrometer thick bulk sample of a material having relatively low transmissivity at λ₁ transmits less than about 0.1% or less of radiation at λ₁ normally incident thereon (e.g., about 0.05% or less, about 0.01% or less, about 0.001% or less, about 0.0001% or less). Low transmissivity materials include materials that absorb a relatively large amount of radiation at λ₁.

In some embodiments, for example, where λ₁ is in the UV portion of the EM spectrum, portions 111 can be formed from titanium dioxide (TiO₂), tungsten (W), indium tin oxide (ITO), molybdenum (Mo), indium phosphide (InP), gallium arsenide (GaAs), aluminum gallium arsenide (AlₓGa₁₋ₓAs), silicon (Si) (e.g., crystalline, semi-crystalline, or amorphous silicon), indium gallium arsenide (InGaAs), germanium (Ge), or gallium phosphide (GaP).

More generally, portions 111 can include inorganic and/or organic materials. Examples of inorganic materials include metals, semiconductors, and inorganic dielectric materials (e.g., glass). Examples of organic materials include polymers.

Portions 111 can be formed from materials that have relatively high absorption at λ₁. A one micrometer thick bulk sample of a material having a relatively high absorption absorbs about 90% or more (e.g., about 93% or more, about 95% or more) of radiation at λ₁ normally incident thereon. In general, depending on λ₁, materials that have a relatively high absorption can include dielectric materials, semiconductor materials, and electrically-conducting materials. Dielectric materials that have a relatively high absorption for certain wavelengths in the UV, for example, include TiO₂. An example of a semiconductor material that has relatively high absorption for certain wavelengths in the UV is silicon (Si). Further examples of semiconductor materials include Ge, indium phosphide (InP), and silicon-germanium (SiGe). Examples of electrically-conducting materials that have a relatively high absorption for certain wavelengths in the UV and visible include cobalt (Co), platinum (Pt), and titanium (Ti). Other materials include chromium (Cr), nickel (Ni), vanadium (V), tantalum (Ta), palladium (Pd), and iridium (Ir). Metal silicides, such as tungsten silicide (WSi₂), titanium silicide (TiSi), tantalum silicide (TaSi), hafnium silicide (HfSi₂), niobium silicide (NbSi), and chromium silicide (CrSi)) can also be used.

In some embodiments, portions 111 are formed from a material that have relatively low transmissivity at λ₂, such as a material that has a relatively low transmissivity across a band of wavelengths including λ₁ and λ₂. For example, W has relatively low transmissivity over the wavelength range from about 200 nm to about 600 nm and can be used to form a linear polarizer film that can be used over a relatively large range of wavelengths that include portions of the UV spectrum. In certain embodiments, the material forming portions 111 has a relatively high absorption at λ₂.

In general, materials can be characterized by a complex index of refraction, ñ=n−ik, where n is the refractive index and k is the extinction coefficient. ñ, in general, varies as a function of wavelength. Portions 111 can be formed from a material that has an extinction coefficient, k, of 1.5 or more (e.g., 1.8 or more, 2 or more, 2.1 or more, 2.2 or more, 2.3 or more, 2.4 or more, 2.5 or more, 2.6 or more, 2.7 or more, 2.8 or more, 2.9 or more, 3 or more, 4 or more) at λ₁. In embodiments, k can be 5 or less (e.g., 4 or less, 3.5 or less). In certain embodiments, k is in a range from 2 to 5. For example, W has a k value of 2.92 at about 633 nm. Additionally, in some embodiments, the material can have a refractive index, n, of 1.5 or more (e.g., 1.8 or more, 2 or more, 2.1 or more, 2.2 or more, 2.3 or more, 2.4 or more, 2.5 or more, 2.6 or more, 2.7 or more, 2.8 or more, 2.9 or more, 3 or more) at λ₁. As an example, W has a n value of 3.65 at about 633 nm. As another example, TiO₂ has an n value of 2.88 at about 633 nm.

In certain embodiments, portions 111 are formed from a material that has an extinction coefficient, k, of 1.5 or more (e.g., 1.8 or more, 2 or more, 2.1 or more, 2.2 or more, 2.3 or more, 2.4 or more, 2.5 or more, 2.6 or more, 2.7 or more, 2.8 or more, 2.9 or more, 3 or more) at λ₂ as well as λ₁. The material can have a refractive index, n, of 1.5 or more (e.g., 1.8 or more, 2 or more, 2.1 or more, 2.2 or more, 2.3 or more, 2.4 or more, 2.5 or more, 2.6 or more, 2.7 or more, 2.8 or more, 2.9 or more, 3 or more) at λ₂.

In general, the material forming portions 111 can include a single component material or from multiple different component materials. In some embodiments, portions 111 are formed from a nanolaminate material, which refers to a composition that is composed of layers of at least two different component materials and the layers of at least one of the materials are extremely thin (e.g., between one and about 10 monolayers thick). Optically, nanolaminate materials have a locally homogeneous index of refraction that depends on the refractive index of its constituent materials. Varying the amount of each constituent material can vary the refractive index of a nanolaminate. Examples of nanolaminate portions include portions composed of silica (SiO₂) monolayers and TiO₂ monolayers, SiO₂ monolayers and tantalum pentoxide (Ta₂O₅) monolayers, or aluminum oxide (Al₂O₃) monolayers and TiO₂ monolayers.

Generally, portions 111 can include crystalline, semi-crystalline, and/or amorphous materials.

The structure and composition of grating layer 110 is selected based on the desired optical performance of linear polarizer film 100. Structural parameters that affect the optical performance of linear polarize 100 include, for example, d, Λ, Λ₁₁₁, and Λ₁₁₂. Typically, varying a single parameter affects multiple different performance parameters. For example, the overall transmittance of the polarizer at λ₁ can be varied by changing the relative thickness of portions 111 formed from a non-transmissive material, Λ₁₁₁, to the thickness of gaps 112, Λ₁₁₂. However, while a lower ratio Λ₁₁₁/Λ₁₁₂ may provide relatively higher transmittance of the pass state polarization, it can also result in higher transmittance of the block state polarization, which decreases E_{T}. As a result, optimizing the polarizer's performance involves trade offs between different performance parameters and the polarizer's structure and composition is varied depending on the desired performance for the polarizer's end use application.

In general, to effectively polarize light at wavelength λ₁, the period Λ of the grating layer should be shorter than λ₁, such as about λ₁/4 or less (e.g., about λ₁/6 or less, about λ₁/10 or less). Moreover, for effective broadband performance, Λ should be shorter than the shortest wavelength in the wavelength band, Δλ. For a broadband polarizer in the visible spectrum, for example, Λ should be less than about 300 nm, such as about 200 nm or less (e.g., about 150 nm or less, about 130 nm or less, about 110 nm or less, about 100 nm or less, about 90 nm or less, about 80 nm or less).

In some embodiments, E_{T} can be increased by increasing the thickness of grating layer 110, d. Increasing d can provide increased E_{T} without substantially reducing the amount of pass state transmittance.

Referring now to other layers in polarizer film 100, in general, substrate 140 provides mechanical support to polarizer film 100. In typical embodiments, where polarizer film 100 is a transmissive polarizer, substrate 140 is transparent to light at wavelength λ₁, transmitting substantially all light impinging thereon at wavelength λ₁ (e.g., about 90% or more, about 95% or more, about 97% or more, about 99% or more, about 99.5% or more).

In general, substrate 140 can be formed from any material compatible with the manufacturing processes used to produce polarizer 100 that can support the other layers. In certain embodiments, substrate 140 is formed from a glass, such as silica glass (e.g., fused quartz or fused silica, such as special UV grade fused silica), BK7 (available from Abrisa Corporation), borosilicate glass (e.g., pyrex available from Corning), and aluminosilicate glass (e.g., C1737 available from Corning). In some embodiments, substrate 140 can be formed from a crystalline material, such as crystalline quartz or calcium fluoride (CaF₂), or, in some cases, a non-linear optical crystal (e.g., LiNbO₃ or a magneto-optical rotator, such as garnett) or a crystalline (or semicrystalline) semiconductor (e.g., Si, InP, or GaAs). Substrate 140 can also be formed from an inorganic material, such as a polymer (e.g., a plastic).

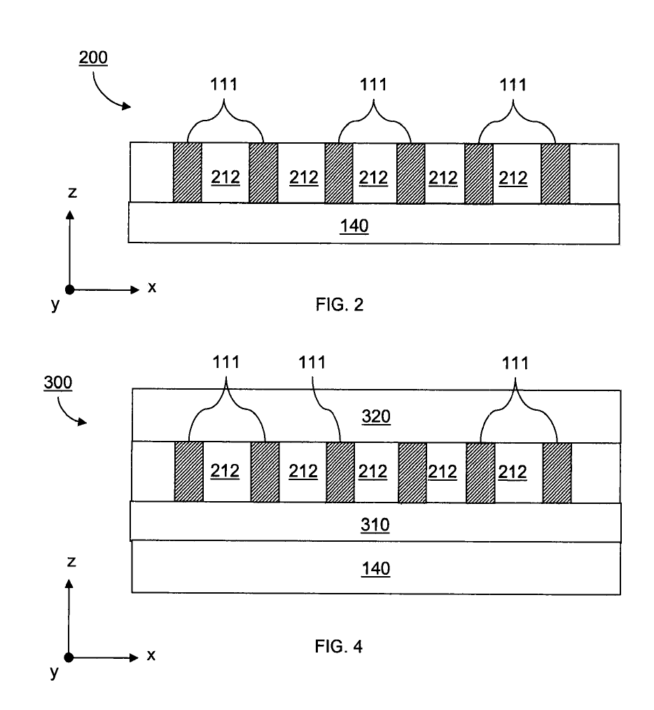

While FIGS. 1A and 1B show a structure having a grating layer on a substrate, the grating layer being a free-standing grating composed portions 111 spaced apart by gaps, in general, polarizers can include additional portions and/or layers. For example, referring to FIG. 2, in some embodiments, a polarizer film 200 includes a material that fills gaps 112 in layer 110, providing a monolithic grating layer 210. In FIG. 2, these portions are designated as portions 212.

Generally, portions 212 are formed from a material that has a significantly higher transmissivity at λ₁ than the material forming 111. For example, the transmissivity of the material forming portions 212 can be about 100 times or more (e.g., about 500 times or more, about 10³ times or more, about 5×10³ times or more, about 10⁴ times or more) higher than the transmissivity of the material forming portions 111. In some embodiments, portions 212 are formed from SiO₂ (e.g., quartz), which is an example of a material that has relatively high transmissivity at visible wavelengths.

In certain embodiments, portions 212 are formed from a material that has a relatively low transmissivity at λ₂. For example, portions 212 can be formed from materials that have relatively high absorption or reflectivity at λ₂.

The material forming portions 212 can be selected so that grating layer 210 linearly polarizes radiation at λ₂, while portions 111 are formed from a material selected so that grating layer 210 linearly polarizes radiation at λ₁. As an example, in some embodiments portions 111 are formed from an oxide material (e.g., TiO₂) that has relatively high absorption in the UV (e.g., at approximately 250 nm) while portions 212 are formed from a metal (e.g., Al) that has relatively high reflectivity or absorption in the visible (e.g., about 450 nm to about 700 nm) and/or IR (e.g., from 700 nm to about 2,000 nm).

In certain embodiments, portions 212 are formed from a material that has an extinction coefficient, k, of 2 or more (e.g., 2.1 or more, 2.2 or more, 2.3 or more, 2.4 or more, 2.5 or more, 2.6 or more, 2.7 or more, 2.8 or more, 2.9 or more, 3 or more) at λ₂. Additionally, in some embodiments, the material can have a refractive index, n, of 2 or more (e.g., 2.1 or more, 2.2 or more, 2.3 or more, 2.4 or more, 2.5 or more, 2.6 or more, 2.7 or more, 2.8 or more, 2.9 or more, 3 or more) at λ₂.

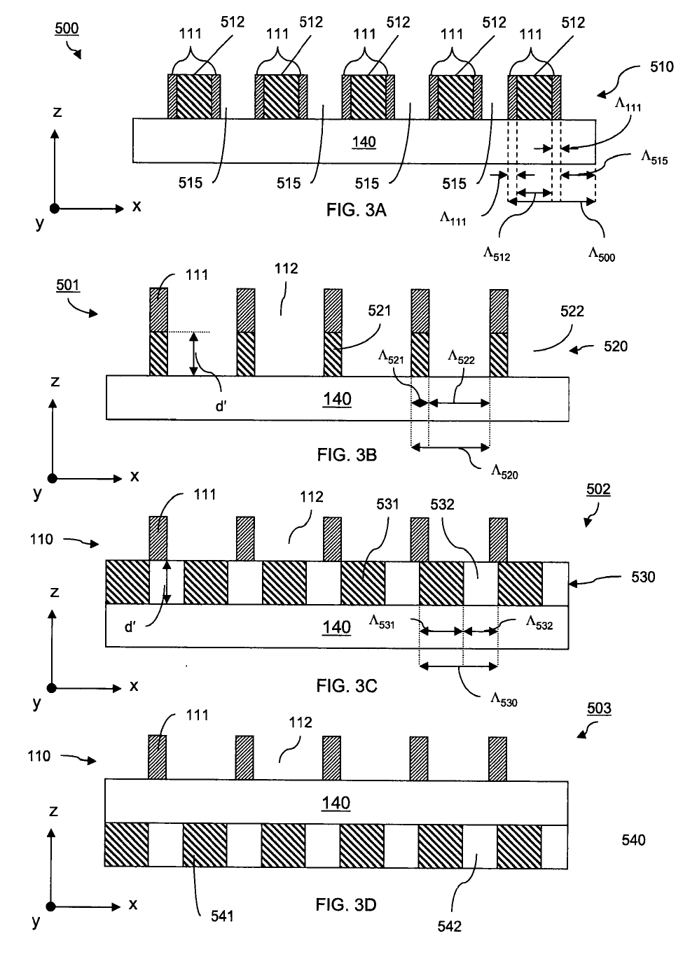

While the grating layer in polarizer film 200 is a monolithic layer (i.e., there are no gaps between the different portions of the layer), embodiments can include some portions that are adjacent portions formed from different materials in addition to some portions that are adjacent to gaps. For example, referring to FIG. 3A, a polarizer film 500 includes a grating layer 510 in which each portion 111 is adjacent a portion 512 formed from a different material on one side, and adjacent a gap 515 on the opposite side. In other words, portions 111 form side walls to portions 512. Portions 512 form a grating having a period Λ₅₀₀.

Portions 512 have a width Λ₅₁₂, while gaps 515 have a width Λ₅₁₅. In general, Λ₅₁₂ and Λ₅₁₅ are selected according to the desired optical properties of polarizer film 500. Λ₅₁₂ can be less than λ₂, such as about λ₂/4 or less (e.g., λ₂/8 or less, λ₂/10 or less, λ₂/12 or less). In other words, portions 512 form a subwavelength grating for radiation at λ₂. Λ₅₁₅ can be the same or different as Λ₅₁₂. Typically, larger values of Λ₅₁₅ correspond to higher transmission of incident radiation at λ₁ and λ₂.

In general, portions 512 are formed from a material that is different from the material forming portions 111. Portions 512 can be formed from a material that has relatively low transmission at λ₂. As an example, in some embodiments portions 111 are formed from an oxide material (e.g., TiO₂) while portions 512 are formed from a metal (e.g., Al) that has relatively high reflectivity in the visible (e.g., about 450 nm to about 700 nm).

In certain embodiments, portions of a material can replace gaps 515, providing a monolithic grating layer 510. For example, portions composed of a material having high transmissivity at λ₁ and λ₂ can be used to replace gaps 515. As an example, where λ₁ and λ₂ are in the UV or visible portions of the spectrum, portions composed of SiO₂ (e.g., quartz) can replace gaps 515.

Polarizer films can include more than one grating layer. For example, referring to FIG. 3B, a polarizer film 501 includes a second grating layer 520 between grating layer 110 and substrate 140. Alternatively, grating layer 110 can be position between grating layer 520 and substrate 140.

The thickness, d′, of grating layer 520 measured along the z-axis can vary as desired. In general, the thickness of layer 520 is selected based on the desired optical properties of grating layer 520 at k, and/or 2 and constraints on the manufacturability of such structures. In some embodiments, d′ can be about 50 nm or more (e.g., about 75 nm or more, about 100 nm or more, about 125 nm or more, about 150 nm or more, about 200 nm or more, about 250 nm or more, about 300 nm or more, about 400 nm or more, about 500 nm or more, about 1,000 or more, such as about 2,000 nm).

In embodiments where gaps 112 are filled with a material, that material can be the same or different as the material filling gaps 522.

As an example, in certain embodiments, portions 111 and 521 have a width of approximately 25 nm and form a grating having a period of about 75 nm. Portions 111 are formed from TiO₂ or W and have a depth of about 100 nm. Portions 521 are formed from Al and have a depth of approximately 50 nm. The gratings in both grating layers are free standing. Substrate 140 is formed from fused silica. In such cases, polarizer film 501 can be effective polarizers for the UV and visible portions of the spectrum.

While the grating formed of portions 521 has the same period and duty cycle as the grating formed from portions 111, in certain embodiments, the period and duty cycle of these gratings can be different. For example, referring to FIG. 3C, a polarizer film 502 includes a grating layer 530 composed from portions 531 and portions 532 which have widths Λ₅₃, and Λ₅₃₂, respectively, forming a grating having a period Λ₅₃₀ different from A.

The period, duty cycle, and depth of the grating in grating layer 530 can be selected based on desired optical properties of the polarizer film at 2. For example, in some embodiments, Λ₅₃₀ is less than 2, such as about 0.5 λ₂ or less (e.g., about 0.32 or less, about 0.2 λ₂ or less, about 0.12 or less, about 0.08 λ₂ or less, about 0.05 λ₂ or less, about 0.04 λ₂ or less, about 0.03 λ₂ or less, about 0.02 λ₂ or less, 0.01)₂ or less). Λ₅₃₀ can be about 1,000 nm or less (e.g., about 500 nm or less, about 300 nm or less, about 200 nm or less, about 150 nm or less, about 100 nm or less).

In general, Λ₅₃₁ can be about 0.2 λ₂ or less (e.g., about 0.1 λ₂ or less, about 0.05 λ₂ or less, about 0.04 λ₂ or less, about 0.03 λ₂ or less, about 0.02 λ₂ or less, 0.01 λ₂ or less). For example, in some embodiments, Λ₅₃₁ is about 500 nm or less (e.g., about 300 nm or less, about 200 nm or less, about 100 nm or less, about 80 nm or less, about 60 nm or less, about 50 nm or less). In some embodiments, Λ₅₃₁ is about 30 nm or more (e.g., about 40 nm or more, about 50 nm or more). Similarly, Λ₅₃₂ can be can be about 0.2 λ₂ or less (e.g., about 0.1)₂ or less, about 0.05 λ₂ or less, about 0.04 λ₂ or less, about 0.03 λ₂ or less, about 0.02 λ₂ or less, 0.01 λ₂ or less). For example, in some embodiments, Λ₅₃₂ is about 500 nm or less (e.g., about 300 nm or less, about 200 nm or less, about 100 nm or less, about 80 nm or less, about 60 nm or less, about 50 nm or less). In some embodiments, Λ₅₃₂ is about 30 nm or more (e.g., about 40 nm or more, about 50 nm or more). Λ₅₃₁ and Λ₅₃₂ can be the same as each other or different.

The duty cycle of grating layer, given by the ratio Λ₅₃₁:Λ₅₃₀, can vary as desired. In some embodiments, the duty cycle is less than about 50% (e.g., about 40% or less, about 30% or less, about 20% or less, about 10% or less, about 8% or less). Alternatively, in certain embodiments, the duty cycle is more than about 50% (e.g., about 60% or more, about 70% or more, about 80% or more).

The aspect ratio of grating layer thickness, d′, to Λ₅₃₁ can be relatively high. For example d′:Λ₅₃₁ can be about 2:1 or more (e.g., about 3:1 or more, about 4:1 or more, about 5:1 or more, about 8:1 or more, about 10:1 or more, about 12:1 or more, about 15:1 or more).

Portions 532 can be formed from a material that has relatively low transmission at λ₂. Portions 532 can be formed from a material that has relatively high transmission at λ₁ and/or λ₂.

In some embodiments, grating layers can be formed on opposing sides of substrate 140. For example, referring to FIG. 3D, a polarizer film 503 includes grating layer 110 on one side of substrate 140, and a second grating layer 540 on the opposite side of substrate 140. Moreover, while the foregoing embodiments include two grating layers, embodiments can include more than two grating layers (e.g., three, four, five or more grating layers).

Embodiments can include additional layers. For example, referring to FIG. 4, a polarizer film 300 includes an etch stop layer 310 and an antireflection film 320.

Etch stop layer 310 is formed from a material resistant to etching processes used to etch the material(s) from which portions 112 are formed. The material(s) forming etch stop layer 130 should also be compatible with substrate 140 and with the materials forming grating layer 110. Examples of materials that can form etch stop layer 130 include HfO₂, SiO₂, Ta₂O₅, TiO₂, SiNe, or metals (e.g., Cr, Ti, Ni).

The thickness of etch stop layer 310 can be varied as desired. Typically, etch stop layer 310 is sufficiently thick to prevent significant etching of substrate 140, but should not be so thick as to adversely impact the optical performance of polarizer film 100. In some embodiments, etch stop layer is about 500 nm or less (e.g., about 250 nm or less, about 100 nm or less, about 75 nm or less, about 50 nm or less, about 40 nm or less, about 30 nm or less, about 20 nm or less).

Antireflection film 320 can reduce the reflectance of pass state light of wavelength λ impinging on and/or exiting polarizer film 100. Antireflection film 320 generally includes one or more layers of different refractive index. As an example, antireflection film 320 can be formed from four alternating high and low index layers. The high index layers can be formed from TiO₂ or Ta₂O₅ and the low index layers can be formed from SiO₂ or MgF₂. The antireflection films can be broadband antireflection films or narrowband antireflection films.

In some embodiments, polarizer films have a reflectance of about 5% or less of light impinging thereon at wavelength λ for pass state polarization (e.g., about 3% or less, about 2% or less, about 1% or less, about 0.5% or less, about 0.2% or less).

In general, polarizer film 100 can be prepared as desired. Generally, polarizer films are prepared using deposition and patterning techniques commonly used in the fabrication of integrated circuits. Deposition techniques that can be used include sputtering (e.g., radio frequency sputtering), evaporating (e.g., electron beam evaporation, ion assisted deposition (IAD) electron beam evaporation), or chemical vapor deposition (CVD) such as plasma enhanced CVD (PECVD), atomic layer deposition (ALD), or by oxidization. Patterning can be performed using lithographic and etching techniques, such as electron beam lithography, photolithography ((e.g., using a photomask or using holographic techniques)), and imprint lithography. Etching techniques include, for example, reactive ion etching, ion beam etching, sputtering etching, chemical assisted ion beam etching (CAIBE), or wet etching.

A discussion of techniques for forming grating structures that can be applied to the structures described herein are discussed in U.S. Patent Publication No. US 2005-0277063 A1, entitled “OPTICAL FILMS AND METHODS OF MAKING THE SAME,” filed on May 27, 2005, the entire contents of which is incorporated herein by reference. In some embodiments, multiple polarizers can be prepared simultaneously by forming a relatively large grating layer on a single substrate, which is then diced into individual units. For example, a grating layer can be formed on a substrate that has a single-side surface area about 10 square inches or more (e.g., a four inch, six inch, or eight inch diameter substrate). After forming the grating layer, the substrate can be diced into multiple units of smaller size (e.g., having a single-side surface area of about one square inch or less).

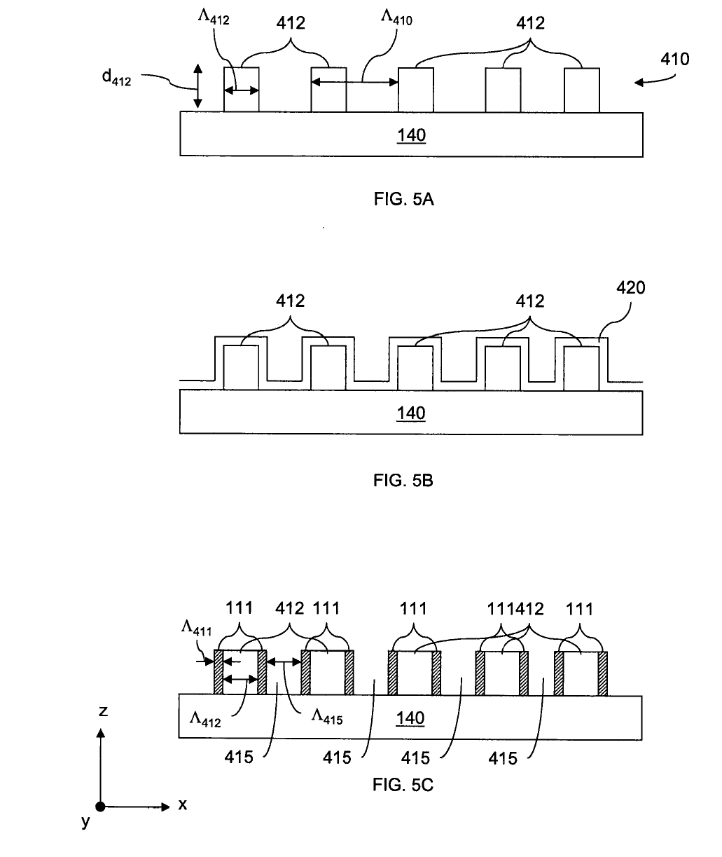

Referring now to FIGS. 5A-5C, in some embodiments, a grating layer with a short period is formed by depositing a material onto the side walls of portions of a primary grating having a relatively longer period. FIG. 5A shows a cross-sectional view of the primary grating layer 410, composed of spaced apart portions 412 supported by substrate 140. Grating layer 410 has a period Λ₄₁₀. Portions 412 have a width Λ₄₁₂ and a thickness d₄₁₂. Portions 412 are formed from a material that has a significantly higher transmissivity at λ₁ than the material forming 111. In some embodiments, portions 412 are formed from silica or quartz.

In certain embodiments, portions 412 are formed from a material having a relatively low transmissivity at λ₂. For example, portions 412 can be formed from a metal, such as Al, Cu, Au, or Ag, which have low transmissivity in the visible portion of the spectrum.

In certain embodiments, portions 412 are formed from the same material as substrate 140. For example, grating layer 410 can be formed by etching portions of a monolithic layer of the substrate material.

Referring to FIG. 5B, a conformal layer 420 is deposited onto the primary grating layer. In certain embodiments, conformal layer 420 is deposited using ALD. ALD deposition is described in detail below. In general, the thickness of conformal layer 420 depends on the desired thickness, Λ₁₁₁, of portions 111.

Referring to FIG. 5C, to form portions 111, conformal layer 420 is anistroptrically etched, leaving substantially only the portions of conformal layer 420 on the sidewalls of portions 412. These remaining portions are portions 111 of the polarizer film. Here, portions 111 on opposing sides of the same portion 412 are separated by a distance Λ₄₁₂, while portions 111 of facing sides of adjacent portions 412 are separated by gaps 415 that have a width Λ₄₁₅, which can be the same or different as Λ₄₁₂. In embodiments where Λ₄₁₂ is different from Λ₄₁₅, the period of the grating formed from portions 111, Λ, is considered to be the average of Λ₁₁₁+Λ₄₁₂ and Λ₁₁₁+Λ₄₁₅. The thickness of this grating is the same as d₄₁₅.

Optionally, portions 412 can be selectively etched away leaving a free standing grating of portions 111.

Methods of forming gratings by depositing materials onto the side walls of existing grating structures are described in Provisional Patent Application No. 60/837,829, entitled “METHODS FOR FORMING PATTERNED STRUCTURES,” filed on Aug. 15, 2006, the entire contents of which is incorporated herein by reference.

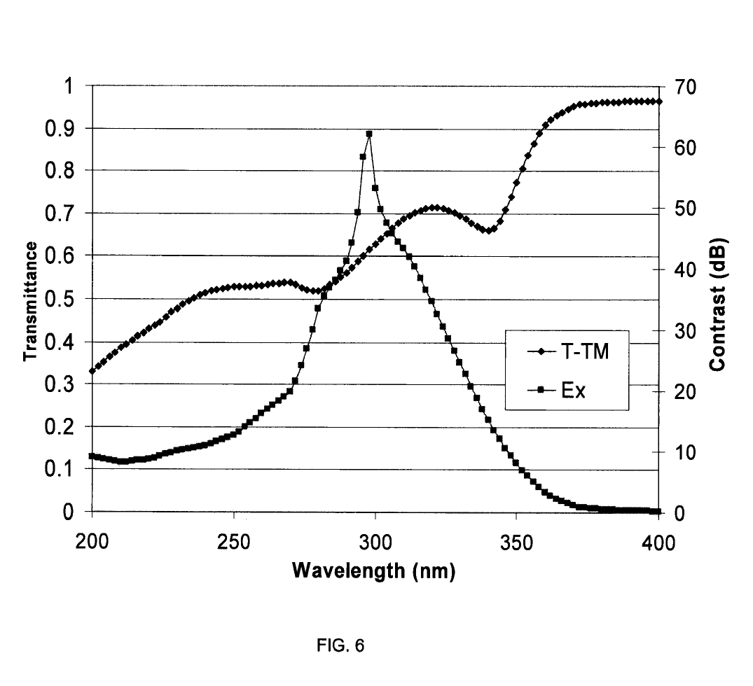

Turning now to the theoretical performance of some exemplary structures, FIG. 6 shows a plot of transmittance (left axis) and extinction ratio (right axis, referred to as contrast) as a function of wavelength (horizontal axis) for a polarizer film composed of a fused silica grating having a period of 148 nm with a width of 37 nm and a thickness of 150 nm. Each wall of the silica grating portions have a 10 nm TiO₂ layer. As can be seen in FIG. 6, the grating has a peak extinction ratio of approximately 63 dB at a wavelength of about 300 nm. Transmittance, which is the transmittance of the pass state radiation, at this wavelength is approximately 60%.

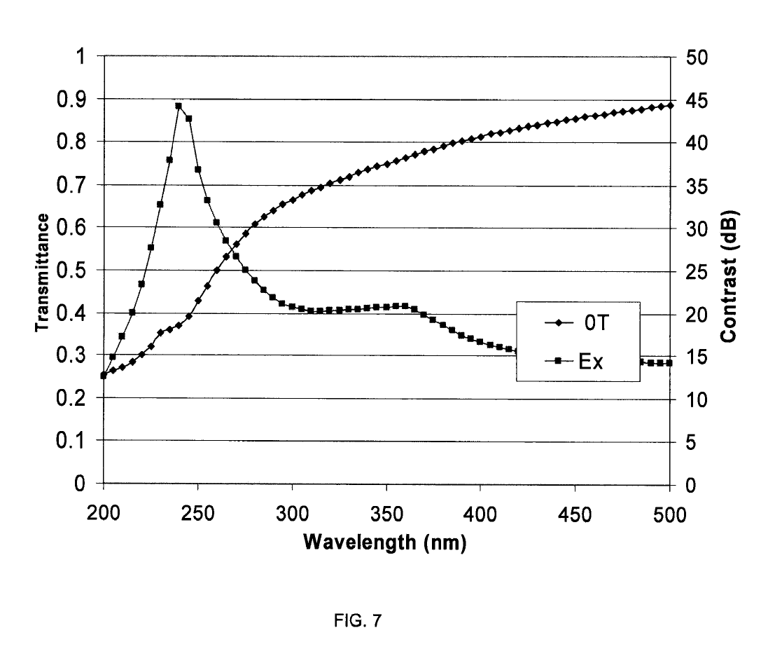

As another example, FIG. 7 shows a plot of transmittance (left axis) and extinction ratio (right axis, referred to as contrast) as a function of wavelength (horizontal axis) for a polarizer film composed of a fused silica grating having a period of 148 nm with a width of 42 nm and a thickness of 150 nm. Each wall of the silica grating portions have a 10 nm tungsten layer. As can be seen in FIG. 7, the grating has a peak extinction ratio of approximately 44 dB at a wavelength of about 240 nm. Transmittance for the pass state at this wavelength is approximately 35%.

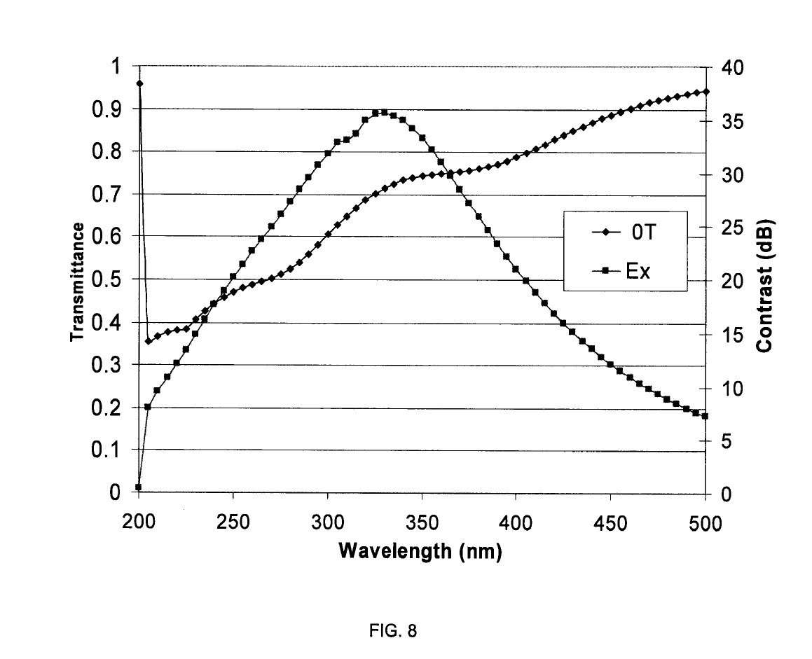

In a further example, FIG. 8 shows a plot of transmittance (left axis) and extinction ratio (right axis, referred to as contrast) as a function of wavelength (horizontal axis) for a polarizer film composed of a fused silica grating having a period of 148 nm with a width of 42 nm and a thickness of 150 nm. Each wall of the silica grating portions have a 10 nm amorphous silicon. As can be seen in FIG. 8, the grating has a peak extinction ratio of approximately 36 dB at a wavelength of about 330 nm. Transmittance for the pass state at this wavelength is approximately 70%.

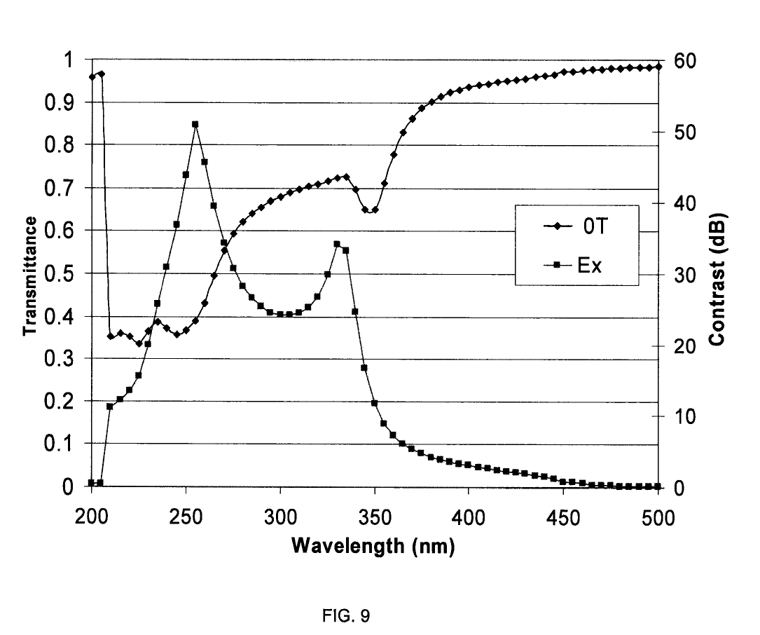

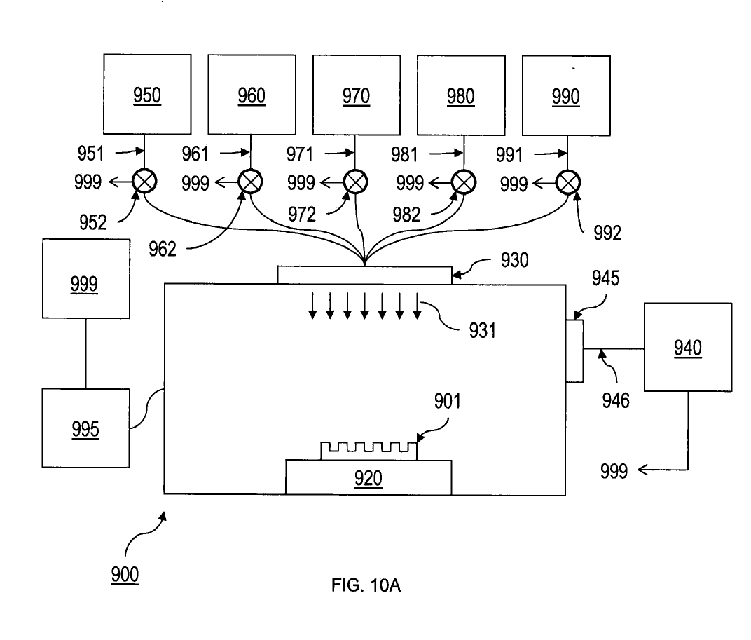

As a further example, FIG. 9 shows a plot of transmittance (left axis) and extinction ratio (right axis, referred to as contrast) as a function of wavelength (horizontal axis) for a polarizer film composed of a fused silica grating having a period of 148 nm with a width of 42 nm and a thickness of 150 nm. Each wall of the silica grating portions have a 10 nm GaP layer. As can be seen in FIG. 9, the grating has a peak extinction ratio of approximately 50 dB at a wavelength of about 250 nm. Transmittance for the pass state at this wavelength is approximately 38%.

The data in FIGS. 6-9 were generated using GSolver software (commercially available from Grating Solver Development Company, Allen, Tex.). Refractive index data (both real and imaginary parts of the refractive index) for all the materials for the examples corresponding to FIGS. 5-8 were taken from the data base coming with the software. This database is from the “Handbook of Optical Constants of Solids” (5 Volume Set) (Hardcover) by Edward D. Palik (Editor), Academic Press.

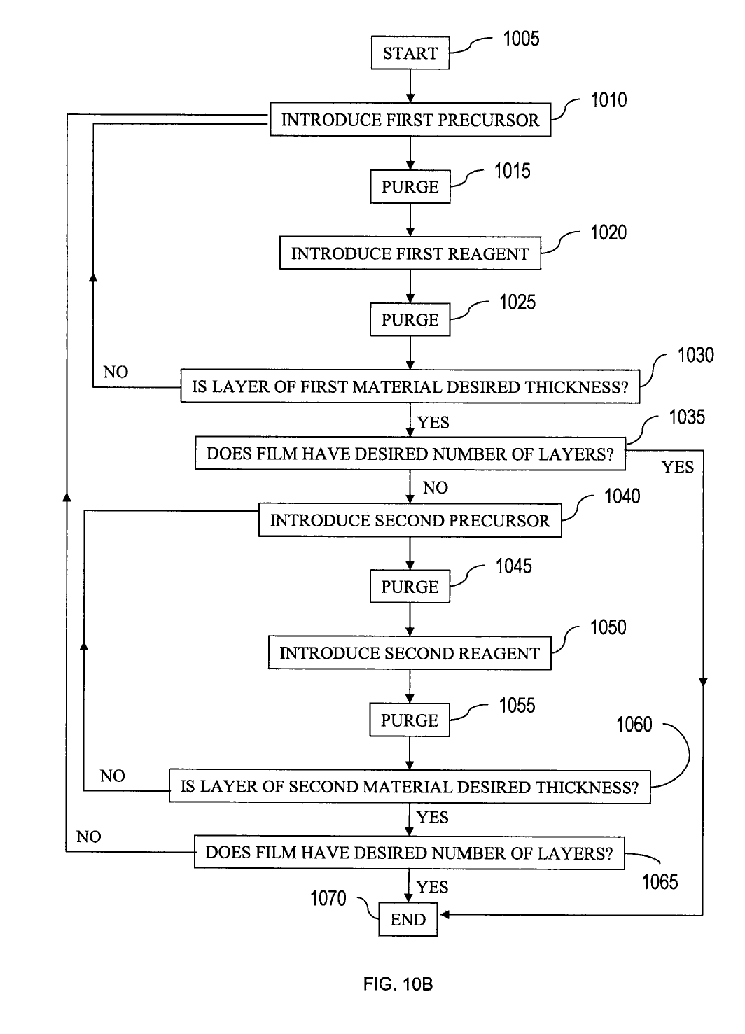

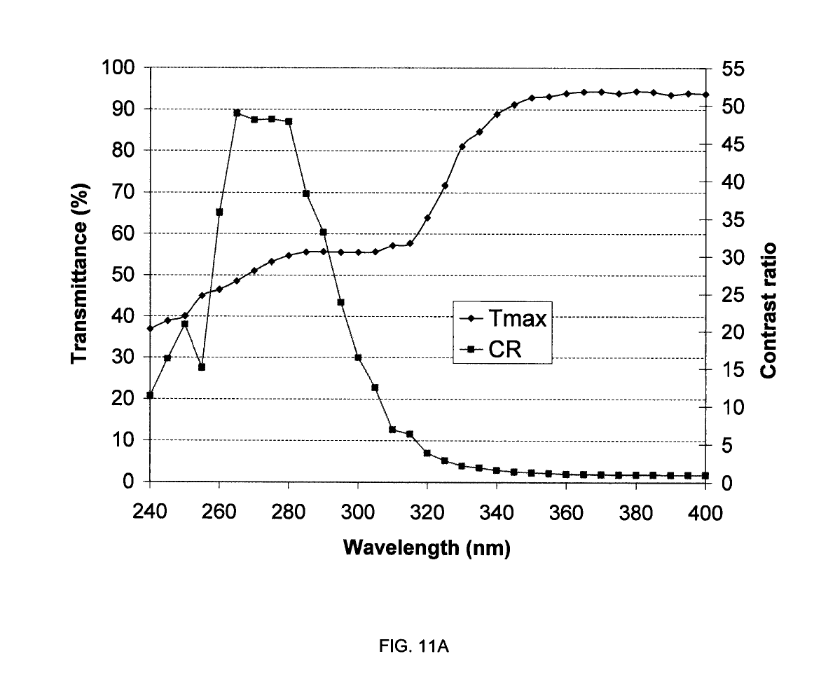

As mentioned previously, in some embodiments, certain portions of the grating layer and/or other layers are prepared using atomic layer deposition (ALD). For example, referring to FIG. 10A, an ALD system 900 is used to deposit material on an intermediate article 901 with, for example, a nanolaminate multilayer film. Deposition of the nanolaminate multilayer film occurs monolayer by monolayer, providing substantial control over the composition and thickness of the films. During deposition of a monolayer, vapors of a precursor are introduced into the chamber and are adsorbed onto exposed surfaces of article 901 or previously deposited monolayers adjacent these surfaces. Subsequently, a reactant is introduced into the chamber that reacts chemically with the adsorbed precursor, forming a monolayer of a desired material. The self-limiting nature of the chemical reaction on the surface can provide precise control of film thickness and large-area uniformity of the deposited layer. Moreover, the non-directional adsorption of precursor onto each exposed surface provides for uniform deposition of material onto the exposed surfaces, regardless of the orientation of the surface relative to chamber B. Accordingly, the layers of the nanolaminate film conform to the shape of the trenches of intermediate article 901.

ALD system 900 includes a reaction chamber 910, which is connected to sources 950, 960, 970, 980, and 990 via a manifold 930. Sources 950, 960, 970, 980, and 990 are connected to manifold 930 via supply lines 951, 961, 971, 981, and 991, respectively. Valves 952, 962, 972, 982, and 992 regulate the flow of gases from sources 950, 960, 970, 980, and 990, respectively. Sources 950 and 980 contain a first and second precursor, respectively, while sources 960 and 990 include a first reagent and second reagent, respectively. Source 970 contains a carrier gas, which is constantly flowed through chamber 910 during the deposition process transporting precursors and reagents to article 901, while transporting reaction byproducts away from the substrate. Precursors and reagents are introduced into chamber 910 by mixing with the carrier gas in manifold 930. Gases are exhausted from chamber 910 via an exit port 945. A pump 940 exhausts gases from chamber 910 via an exit port 945. Pump 940 is connected to exit port 945 via a tube 946.

ALD system 900 includes a temperature controller 995, which controls the temperature of chamber 910. During deposition, temperature controller 995 elevates the temperature of article 901 above room temperature. In general, the temperature should be sufficiently high to facilitate a rapid reaction between precursors and reagents, but should not damage the substrate. In some embodiments, the temperature of article 901 can be about 500° C. or less (e.g., about 400° C. or less, about 300° C. or less, about 200° C. or less, about 150° C. or less, about 125° C. or less, about 100° C. or less).

Typically, the temperature should not vary significantly between different portions of article 901. Large temperature variations can cause variations in the reaction rate between the precursors and reagents at different portions of the substrate, which can cause variations in the thickness and/or morphology of the deposited layers. In some embodiments, the temperature between different portions of the deposition surfaces can vary by about 40° C. or less (e.g., about 30° C. or less, about 20° C. or less, about 10° C. or less, about 5° C. or less).

Deposition process parameters are controlled and synchronized by an electronic controller 999. Electronic controller 999 is in communication with temperature controller 995; pump 940; and valves 952, 962, 972, 982, and 992. Electronic controller 999 also includes a user interface, from which an operator can set deposition process parameters, monitor the deposition process, and otherwise interact with system 900.

Referring to FIG. 10B, the ALD process is started (1005) when system 900 introduces the first precursor from source 950 into chamber 910 by mixing it with carrier gas from source 970 (1010). A monolayer of the first precursor is adsorbed onto exposed surfaces of article 901, and residual precursor is purged from chamber 910 by the continuous flow of carrier gas through the chamber (1015). Next, the system introduces a first reagent from source 960 into chamber 910 via manifold 930 (1020). The first reagent reacts with the monolayer of the first precursor, forming a monolayer of the first material. As for the first precursor, the flow of carrier gas purges residual reagent from the chamber (1025). Steps 1010 through 1025 are repeated until the layer of the first material reaches a desired thickness (1030).

In embodiments where the films are a single layer of material, the process ceases once the layer of first material reaches the desired thickness (1035). However, for a nanolaminate film, the system introduces a second precursor into chamber 910 through manifold 930 (1040). A monolayer of the second precursor is adsorbed onto the exposed surfaces of the deposited layer of first material and carrier gas purges the chamber of residual precursor (1045). The system then introduces the second reagent from source 980 into chamber 910 via manifold 930. The second reagent reacts with the monolayer of the second precursor, forming a monolayer of the second material (1050). Flow of carrier gas through the chamber purges residual reagent (1055). Steps 580 through 510 are repeated until the layer of the second material reaches a desired thickness (1060).

Additional layers of the first and second materials are deposited by repeating steps 1040 through 1055. Once the desired number of layers are formed (e.g., the trenches are filled and/or cap layer has a desired thickness), the process terminates (1070), and the coated article is removed from chamber 910.

Although the precursor is introduced into the chamber before the reagent during each cycle in the process described above, in other examples the reagent can be introduced before the precursor. The order in which the precursor and reagent are introduced can be selected based on their interactions with the exposed surfaces. For example, where the bonding energy between the precursor and the surface is higher than the bonding energy between the reagent and the surface, the precursor can be introduced before the reagent. Alternatively, if the binding energy of the reagent is higher, the reagent can be introduced before the precursor.

The thickness of each monolayer generally depends on a number of factors. For example, the thickness of each monolayer can depend on the type of material being deposited. Materials composed of larger molecules may result in thicker monolayers compared to materials composed of smaller molecules.

The temperature of the article can also affect the monolayer thickness. For example, for some precursors, a higher temperature can reduce adsorption of a precursor onto a surface during a deposition cycle, resulting in a thinner monolayer than would be formed if the substrate temperature were lower.

The type or precursor and type of reagent, as well as the precursor and reagent dosing can also affect monolayer thickness. In some embodiments, monolayers of a material can be deposited with a particular precursor, but with different reagents, resulting in different monolayer thickness for each combination. Similarly, monolayers of a material formed from different precursors can result in different monolayer thickness for the different precursors.

Examples of other factors which may affect monolayer thickness include purge duration, residence time of the precursor at the coated surface, pressure in the reactor, physical geometry of the reactor, and possible effects from the byproducts on the deposited material. An example of where the byproducts affect the film thickness are where a byproduct etches the deposited material. For example, HCl is a byproduct when depositing TiO₂ using a TiCl₄ precursor and water as a reagent. HCl can etch the deposited TiO₂ before it is exhausted. Etching will reduce the thickness of the deposited monolayer, and can result in a varying monolayer thickness across the substrate if certain portions of the substrate are exposed to HCl longer than other portions (e.g., portions of the substrate closer to the exhaust may be exposed to byproducts longer than portions of the substrate further from the exhaust).

Typically, monolayer thickness is between about 0.1 nm and about five nm. For example, the thickness of one or more of the deposited monolayers can be about 0.2 nm or more (e.g., about 0.3 nm or more, about 0.5 nm or more). In some embodiments, the thickness of one or more of the deposited monolayers can be about three nm or less (e.g., about two nm, about one nm or less, about 0.8 nm or less, about 0.5 nm or less).

The average deposited monolayer thickness may be determined by depositing a preset number of monolayers on a substrate to provide a layer of a material. Subsequently, the thickness of the deposited layer is measured (e.g., by ellipsometry, electron microscopy, or some other method). The average deposited monolayer thickness can then be determined as the measured layer thickness divided by the number of deposition cycles. The average deposited monolayer thickness may correspond to a theoretical monolayer thickness. The theoretical monolayer thickness refers to a characteristic dimension of a molecule composing the monolayer, which can be calculated from the material's bulk density and the molecules molecular weight. For example, an estimate of the monolayer thickness for SiO₂ is ˜0.37 nm. The thickness is estimated as the cube root of a formula unit of amorphous SiO₂ with density of 2.0 grams per cubic centimeter.

In some embodiments, average deposited monolayer thickness can correspond to a fraction of a theoretical monolayer thickness (e.g., about 0.2 of the theoretical monolayer thickness, about 0.3 of the theoretical monolayer thickness, about 0.4 of the theoretical monolayer thickness, about 0.5 of the theoretical monolayer thickness, about 0.6 of the theoretical monolayer thickness, about 0.7 of the theoretical monolayer thickness, about 0.8 of the theoretical monolayer thickness, about 0.9 of the theoretical monolayer thickness). Alternatively, the average deposited monolayer thickness can correspond to more than one theoretical monolayer thickness up to about 30 times the theoretical monolayer thickness (e.g., about twice or more than the theoretical monolayer thickness, about three time or more than the theoretical monolayer thickness, about five times or more than the theoretical monolayer thickness, about eight times or more than the theoretical monolayer thickness, about 10 times or more than the theoretical monolayer thickness, about 20 times or more than the theoretical monolayer thickness).

During the deposition process, the pressure in chamber 910 can be maintained at substantially constant pressure, or can vary. Controlling the flow rate of carrier gas through the chamber generally controls the pressure. In general, the pressure should be sufficiently high to allow the precursor to saturate the surface with chemisorbed species, the reagent to react completely with the surface species left by the precursor and leave behind reactive sites for the next cycle of the precursor. If the chamber pressure is too low, which may occur if the dosing of precursor and/or reagent is too low, and/or if the pump rate is too high, the surfaces may not be saturated by the precursors and the reactions may not be self limited. This can result in an uneven thickness in the deposited layers. Furthermore, the chamber pressure should not be so high as to hinder the removal of the reaction products generated by the reaction of the precursor and reagent. Residual byproducts may interfere with the saturation of the surface when the next dose of precursor is introduced into the chamber. In some embodiments, the chamber pressure is maintained between about 0.01 Torr and about 100 Torr (e.g., between about 0.1 Torr and about 20 Torr, between about 0.5 Torr and 10 Torr, such as about 1 Torr).

Generally, the amount of precursor and/or reagent introduced during each cycle can be selected according to the size of the chamber, the area of the exposed substrate surfaces, and/or the chamber pressure. The amount of precursor and/or reagent introduced during each cycle can be determined empirically.

The amount of precursor and/or reagent introduced during each cycle can be controlled by the timing of the opening and closing of valves 952, 962, 982, and 992. The amount of precursor or reagent introduced corresponds to the amount of time each valve is open each cycle. The valves should open for sufficiently long to introduce enough precursor to provide adequate monolayer coverage of the substrate surfaces. Similarly, the amount of reagent introduced during each cycle should be sufficient to react with substantially all precursor deposited on the exposed surfaces. Introducing more precursor and/or reagent than is necessary can extend the cycle time and/or waste precursor and/or reagent. In some embodiments, the precursor dose corresponds to opening the appropriate valve for between about 0.1 seconds and about five seconds each cycle (e.g., about 0.2 seconds or more, about 0.3 seconds or more, about 0.4 seconds or more, about 0.5 seconds or more, about 0.6 seconds or more, about 0.8 seconds or more, about one second or more). Similarly, the reagent dose can correspond to opening the appropriate valve for between about 0.1 seconds and about five seconds each cycle (e.g., about 0.2 seconds or more, about 0.3 seconds or more, about 0.4 seconds or more, about 0.5 seconds or more, about 0.6 seconds or more, about 0.8 seconds or more, about one second or more).

The time between precursor and reagent doses corresponds to the purge. The duration of each purge should be sufficiently long to remove residual precursor or reagent from the chamber, but if it is longer than this it can increase the cycle time without benefit. The duration of different purges in each cycle can be the same or can vary. In some embodiments, the duration of a purge is about 0.1 seconds or more (e.g., about 0.2 seconds or more, about 0.3 seconds or more, about 0.4 seconds or more, about 0.5 seconds or more, about 0.6 seconds or more, about 0.8 seconds or more, about one second or more, about 1.5 seconds or more, about two seconds or more). Generally, the duration of a purge is about 10 seconds or less (e.g., about eight seconds or less, about five seconds or less, about four seconds or less, about three seconds or less).

The time between introducing successive doses of precursor corresponds to the cycle time. The cycle time can be the same or different for cycles depositing monolayers of different materials. Moreover, the cycle time can be the same or different for cycles depositing monolayers of the same material, but using different precursors and/or different reagents. In some embodiments, the cycle time can be about 20 seconds or less (e.g., about 15 seconds or less, about 12 seconds or less, about 10 seconds or less, about 8 seconds or less, about 7 seconds or less, about 6 seconds or less, about 5 seconds or less, about 4 seconds or less, about 3 seconds or less). Reducing the cycle time can reduce the time of the deposition process.

The precursors are generally selected to be compatible with the ALD process, and to provide the desired deposition materials upon reaction with a reagent. In addition, the precursors and materials should be compatible with the material on which they are deposited (e.g., with the substrate material or the material forming the previously deposited layer). Examples of precursors include chlorides (e.g., metal chlorides), such as TiCl₄, SiCl₄, SiH₂Cl₂, TaCl₃, HfCl₄, InCl₃ and AlCl₃. In some embodiments, organic compounds can be used as a precursor (e.g., Ti-ethaOxide, Ta-ethaOxide, Nb-ethaOxide). Another example of an organic compound precursor is (CH₃)₃Al. For SiO₂ deposition, for example, suitable precursors include Tris(tert-butoxy), Tris(tert-pentoxy) silanol, or tetraethoxysilane (TEOS).

The reagents are also generally selected to be compatible with the ALD process, and are selected based on the chemistry of the precursor and material. For example, where the material is an oxide, the reagent can be an oxidizing agent. Examples of suitable oxidizing agents include water, hydrogen peroxide, oxygen, ozone, (CH₃)₃Al, and various alcohols (e.g., Ethyl alcohol CH₃OH). Water, for example, is a suitable reagent for oxidizing precursors such as TiCl₄ to obtain TiO₂, AlCl₃ to obtain Al₂O₃, and Ta-ethaoxide to obtain Ta₂O₅, Nb-ethaoxide to obtain Nb₂O₅, HfCl₄ to obtain HfO₂, ZrCl₄ to obtain ZrO₂, and InCl₃ to obtain In₂O₃. In each case, HCl is produced as a byproduct. In some embodiments, (CH₃)₃Al can be used to oxidize silanol to provide SiO₂.

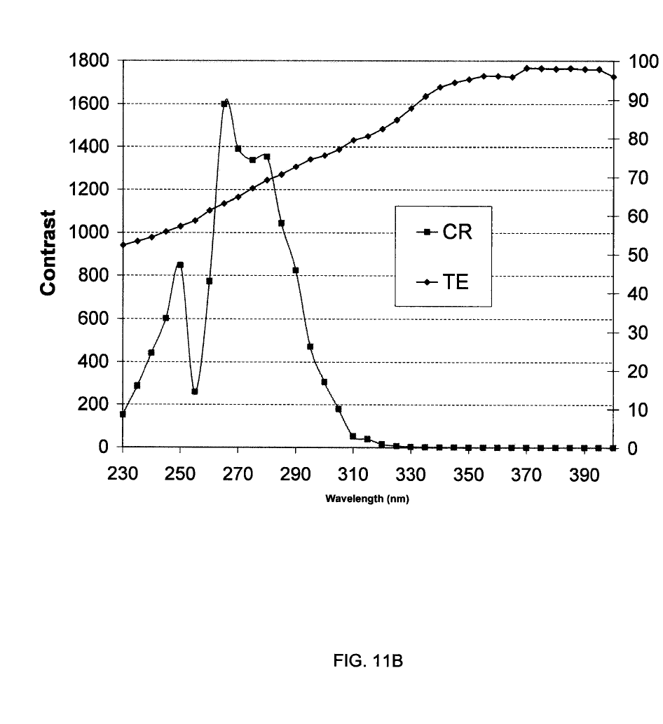

Optical performance data from an exemplary polarizer film are shown in FIG. 11A. In particular, FIG. 11A shows a plot of transmittance (left axis) and extinction ratio (right axis, referred to as contrast) as a function of wavelength (horizontal axis) for a polarizer film composed of a fused silica grating having a period of 148 nm supported by a fused silica substrate. Each wall of the silica grating portions have a 10 nm TiO₂ layer. Prior to the deposition of the TiO₂, the silica grating portions had a width of 55 nm and a thickness of 150 nm. The TiO₂ layer was deposited on the silica grating using ALD at 300° C. and subsequently etched by reactive ion etching (using a Plasma Therm 720 machine, with gas flow of CF₄ 5 sccm, O₂ 0.5 sccm, at a pressure of 8 mtorr, and at a power of 100 W). As can be seen in FIG. 11A, the grating has a peak extinction ratio of approximately 50 at a wavelength of about 265 nm. Transmittance for the past state at this wavelength is approximately 50%.

Optical performance data from another exemplary polarizer film are shown in FIG. 11B. Here, the polarizer film was formed by initially forming a sacrificial aluminum grating on a fused silica substrate. The aluminum grating had a period of 148 nm, a line width of 37 nm, and a depth of 200 nm. A 20 nm thick TiO₂ film was deposited onto the aluminum grating using ALD at 300° C. and subsequently etched by reactive ion etching (using a Plasma Therm 720 machine, with gas flow of CF₄ 5 sccm, O₂ 0.5 sccm, at a pressure of 8 mtorr, and at a power of 100 W). Subsequently, the aluminum grating was etched away by wet etching in KOH for 2 minutes. As an alternative, reactive ion etching using Cl₂/BCl₃, for example, can be used to etch the aluminum grating. The etch method used to remove the aluminum grating can be the same as the method used to form the aluminum grating. Etching the aluminum grating leaves a free-standing TiO₂ grating. As can be seen in FIG. 11B, the grating has a peak extinction ratio of approximately 1,600 at a wavelength of about 265 nm. Transmittance for the past state at this wavelength is approximately 60%.

While certain embodiments have been described, in general, other linear polarizer structures are also possible. For example, while FIGS. 1A, 1B, 2, 3A-3D, and 4 show a variety of configurations of polarizer films, other embodiments can include additional or fewer layers. For example, in some embodiments, polarizers can include additional antireflection films (e.g., between substrate layer 140 and etch stop layer 310 in polarizer film 300). Embodiments can also include protective layers, such as hardcoat layers (e.g., hardcoat polymers).

Although embodiments of polarizers have been described that include a grating layer that has a rectangular grating profile, other embodiments are also possible. For example, in some embodiments, the grating layer have a curved profile, such as a sinusoidal profile. Alternatively, the grating layer can have a triangular profile, sawtooth profile, or trapezoidal profile. Moreover, in general, the profile of grating layers may vary slightly from its designated geometry (e.g., rectangular, triangular, trapezoidal) due to imperfections associated with the manufacturing process.

Furthermore, while the grating period in the grating layers of polarizers has been described as constant, in certain embodiments the grating period may vary. In some embodiments, portions of grating layers can be arranged non-periodically.

Polarizer films such as those described herein can be incorporated into optical devices, including passive optical devices (e.g., polarizing devices) and active optical devices (e.g., liquid crystal displays). Polarizer films can be integrated into the device, providing a monolithic device, or can be arranged separately from other components of the device.

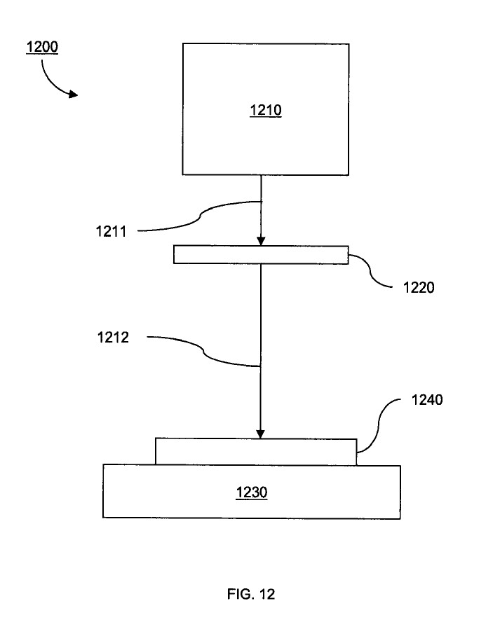

In certain embodiments, polarizer films can be used in applications to provide polarized UV radiation to a substrate. Referring to FIG. 12, a UV exposure system 1200 includes a UV source 1210, a polarizer film 1220, and a substrate support 1230 configured to position a substrate 1240 to receive radiation from UV source 1210. Radiation 1211 emitted from source 1210 passes through polarizer film 1220, emerging as polarized radiation 1212 directed to substrate 1240. Optionally, system 1200 can include optical elements between source 1210 and polarizer film 1220 and/or between polarizer film 1220 and substrate 1240. The optical elements can be used to control (e.g., homogenize) the illumination of the substrate by source 1210. As an example, in some embodiments, UV exposure system 1200 can be used to expose liquid crystal alignment layers, e.g., on a surface of an LCD panel.

As another example, polarizer films can be used in lithography exposure tools that utilize UV radiation to expose resist layers on wafers or LCD substrates.

UV polarizers can also be used in the metrology system for wafer inspection (e.g., such as in commercially-available metrology systems like the Surfscan systems available from KLA-Tencor, San Jose, Calif.), where narrowband UV light (e.g., at about 266 nm) and/or broadband UV light (e.g., from about 240 nm to about 450 nm) is used to illuminate wafers and detect light reflected from the wafers. Information about the wafers can be determined based on the reflected light. UV polarizers can be used to polarize the incident illumination and/or analyze the reflected illumination, thereby providing polarization-dependent information about the wafer and/or enhancing the resolution of the system relative to systems that utilize unpolarized light.

A number of embodiments have been described. Other embodiments are in the following claims.

What is claimed is:

1. An article, comprising:
a layer including a plurality of spaced-apart portions of a first material extending along a first direction, wherein:
the layer transmits about 20% or more of light of wavelength λ having a first polarization state incident on the layer along a path,
the layer transmits about 2% or less of light of wavelength λ having a second polarization state incident on the layer along the path, the first and second polarization states being orthogonal,
for wavelength λ, the first material has a refractive index of 1.8 or more and an extinction coefficient of 1.8 or more, and
λ is 300 nm or less.

2. The article of claim 1, wherein the first material is a metal.

3. The article of claim 2, wherein the metal is tungsten, titanium, chromium, nickel, Pt, molybdenum, vanadium, palladium, or iridium.

4. The article of claim 1, wherein the first material is a metal oxide.

5. The article of claim 4, wherein the metal oxide is titanium dioxide or indium tin oxide.

6. The article of claim 1, wherein the first material is a semiconductor material.

7. The article of claim 6, wherein the semiconductor material is silicon, germanium, indium phosphide, or SiGe.

8. The article of claim 1, wherein the first material is a metal silicide.

9. The article of claim 1, wherein the adjacent spaced apart portions are separated by a distance of about 150 nm or less.

10. The article of claim 1, wherein the spaced apart portions have a depth of about 50 nm or more.

11. The article of claim 1, wherein the spaced apart portions have an aspect ratio of about 1:1 or more.

12. The article of claim 1, wherein the spaced apart portions are arranged to form a grating.

13. The article of claim 12, wherein the grating has a period of about 200 nm or less.

14. The article of claim 12, wherein the grating has a duty cycle of about 60% or less.

15. The article of claim 12, wherein the grating has a rectangular, trapezoidal, or triangular cross-sectional profile.

16. The article of claim 1, further comprising a plurality of spaced apart portions of a second material extending along the first direction, wherein the first and second materials are different.

17. The article of claim 16, wherein the second material is a metal.

18. The article of claim 17, wherein the second material is Al, Au, Ag, or Cu.

19. The article of claim 16, wherein the second material is a dielectric material.

20. The article of claim 16, wherein the second material is an oxide.

21. The article of claim 16, wherein each two portions of the first material are disposed on opposing surfaces of a corresponding portion of the second material.

22. The article of claim 21, wherein the two portions of the first material form side walls of the corresponding portion of the second material.

23. The article of claim 22, wherein portions of the first material that form side walls of adjacent portions of the second material are separated by a gap.

24. The article of claim 1, wherein λ is about 260 nm or less.

25. The article of claim 24, wherein λ is in a range from about 230 nm to about 260 nm.

26. The article of claim 1, the layer transmits about 30% or more of light of wavelength λ having the first polarization state incident on the layer along the path.

27. The article of claim 1, wherein the layer transmits about 1% or less of light of wavelength λ having the second polarization state incident on the layer along the path.

28. The article of claim 1, wherein the layer has an extinction ration of about 30 or more at λ.

29. The article of claim 1, wherein the layer reflects about 20% or less of light of wavelength λ having the second polarization state incident on the layer along the path.

30. The article of claim 1, further comprising a second layer including a plurality of spaced-apart portions of a second material extending along the first direction, the second material being different from the first material, wherein:
the second layer transmits about 20% or more of light of wavelength λ having the first polarization state incident on the layer along the path,
the layer transmits about 2% or less of light of wavelength λ having the second polarization state incident on the layer along the path, the first and second polarization states being orthogonal, and λ<λ′.

31. The article of claim 30, wherein λ′ is in a range from about 400 nm to about 700 nm.

32. The article of claim 30, wherein the first material is a dielectric material and the second material is a metal.

33. The article of claim 1, further comprising a substrate supporting the layer.

34. A system, comprising:
a radiation source; and
the article of claim 1,
wherein the radiation source is configured to direct radiation at λ toward the article.

35. A method, comprising:
using the article of claim 1 to provide polarized radiation at 2; and
directing the polarized radiation to a target.

36. The method of claim 35, wherein the target comprises an alignment layer for a liquid crystal display.

37. An article, comprising:
a layer including a plurality of spaced-apart portions of a first material extending along a first direction, wherein:
the layer transmits about 20% or more of light of wavelength λ having a first polarization state incident on the layer along a path,
the layer transmits about 2% or less of light of wavelength λ having a second polarization state incident on the layer along the path, the first and second polarization states being orthogonal,
the first material is a metal oxide, tungsten, or silicon, and
λ is 300 nm or less.

38. An article, comprising:
a layer including a plurality of spaced-apart portions of a first material extending along a first direction, wherein:
for a cross-sectional profile through the layer orthogonal to the first direction, adjacent portions have a minimum separation of about 100 nm or less and the portions have a width of about 100 nm or less,
for wavelength λ, the first material has a refractive index of 1.8 or more and an extinction coefficient of 1.8 or more, and
λ is 300 nm or less.

39. An article, comprising:
a layer including a plurality of spaced-apart portions of a first material extending along a first direction, wherein:
for a cross-sectional profile through the layer orthogonal to the first direction, adjacent portions have a minimum separation of about 100 nr or less and the portions have a width of about 100 nm or less,
the first material is a metal oxide, tungsten, or silicon, and
λ is 300 nm or less.

40. An article, comprising:
a layer comprising:
a plurality of spaced apart portions of a first material arranged to form a first grating having a first period; and
a plurality of spaced apart portions of a second material arranged to form a second grating having a second period,
wherein the first and second periods are different, one of the first and second materials is a metal, the other of the first and second materials is a dielectric material, and adjacent portions of the first material are separated by two adjacent portions of the second material.
